(19) United States
(12) Patent Application Publication
(10) Pub. No.: US 2006/0123351 A1
(43) Pub. Date: Jun. 8, 2006

(54) System and method for communicating objects status within a virtual environment using translucency

(75) Inventor: Andrew Littlefield, San Francisco, CA (US)

Correspondence Address: FLIESLER MEYER, LLP, FOUR EMBARCADERO CENTER, SUITE 400, SAN FRANCISCO, CA, 94111, US

(73) Assignee: Evil Twin Studios, Inc., San Francisco, CA (US)

(21) Appl. No.: 11/292,666

(22) Filed: Dec. 2, 2005

Related U.S. Application Data
(60) Provisional application No. 60/634,469, filed on Dec. 8, 2004.

(51) Int. Cl. G06F 17/00

(52) U.S. Cl. 715/768

(57) ABSTRACT

A system and method for communicating object status in a virtual environment through the use of translucency when displaying such objects. The invention is generally related to virtual environments, gaming environments, online communities, and interactive computing, and is specifically related to the use of translucency when displaying objects in a virtual environment to indicate status of such objects.

### CLAIM OF PRIORITY

This application claims priority to U.S. Provisional Application No. 60/634,469 entitled “System and Method for Communicating Objects Status Within a Virtual Environment Using Translucency” by Andrew Littlefield, filed Dec. 8, 2004 [Attorney Docket No. EVTWS-01002US0].

### CROSS REFERENCES

This application is related to U.S. patent application Ser. No. 11/244,850 entitled “System and Method for Integration of Instant Messaging and Virtual Environment Clients” by Andrew Littlefield, filed Oct. 6, 2005 [Attorney Docket No. EVTWS-01000US1]; U.S. patent application Ser. No. ______ entitled “System and Method for Organizing Online Communities and Virtual Dwelling Within a Virtual Environment” by Andrew Littlefield, filed Dec. 2, 2005 [Attorney Docket No. EVTWS-01001US1]; and U.S. patent application Ser. No. ______ entitled “System and Method for Communicating Travel Progress Within a Virtual Environment” by Andrew Littlefield, filed Dec. 2, 2005 [Attorney Docket No. EVTWS-01003US1], all are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The invention is generally related to virtual environments, gaming environments, online communities, and interactive computing, and is specifically related to the use of translucency when displaying objects in a virtual environment to indicate status of such objects.

### BACKGROUND

Virtual Environments

A virtual environment is a computer-simulated environment intended for its users to inhabit and interact with via avatars. This habitation usually is represented in the form of two or three-dimensional graphical representations of humanoids (or other graphical or text-based avatars). Some, but not all, virtual worlds allow for multiple users.

The world being simulated typically appears similar to the real world, with real world rules such as gravity, topography, locomotion, real-time, and communication.

The earliest instances of virtual environments can be traced back to 1978, when Roy Trubshaw introduced the first release of the Multi User Dungeon (MUD) program. MUD was purely text based, relied upon textual descriptions of the virtual environments and characters, with users interacting via text commands also. An example of a MUD gaming session is shown in FIG. 1.

MUD allowed multiple users (or game characters) to explore the same virtual world simultaneously. It also allowed characters to interact with each other in various forms ranging from conversation to a fight to the death. Users could interact with environmental objects, in which case the system provided stateful tracking of those objects (e.g. a player can drop a coin in a room, and should another player visit that same room at a later time they will be able to see that same coin object and interact with it). The MUD program also allowed players to create their own virtual environments and game spaces using a built-in scripting language so allowing expansion of the virtual environment by end users. This extensibility coupled with strong game play elements proved to be very popular at the time of release, with several MUD deployments still in use today. More importantly the MUD provided the functional blueprints on which many virtual environments still utilize to this day.

The popularity of the original MUD did not go unnoticed by commercial vendors, who developed the second generation of virtual environments in the mid eighties. This second generation of virtual worlds, leveraged the same text based interaction model and the same basic game play elements as MUD. However this second generation differed from the first in terms of the scale of the virtual environments and the maximum number of simultaneous users that the virtual worlds could support.

This second generation of virtual environments were introduced to the general public in the U.S. and in Europe by the then dominant online providers, including Compuserve, Prestel and CompuNet. These initial commercial offerings proved to be massive initial success in the US where flat rate local phone calls where commonplace so allowing gamers to connect to local POPs with zero incremental costs. However in the UK and most of Europe local telephone calls where charged by the minute, and so resulting in extensive telephone bills. The popularity of these games/virtual environments allowed CompuServe to capture over one million users over a period of three years. Other online services, including AOL soon followed suit and offered similar environments as part of their service offerings. AOL soon rose to become the dominant online service provider in the US and virtual environments remained a major part of the offerings made to users. This resulted in AOL becoming the preeminent distribution channel for virtual world developers as the AOL user base grew to dwarf the other online providers. The reliance upon a single distribution channel left many virtual world developers in a vulnerable position and would eventually cause their demise.

Many of these free virtual environments were running variants of TinyMUD developed by Jim Aspnes at Carnegie Mellon University. TinyMUD was one of the first virtual environments to be ported to the Unix operating system which had become the de facto server OS of choice of Universities and large corporations by the mid nineties. This resulted in just about anyone with reasonable access permissions to a university or corporate server being able to host their own virtual environment for use by their friends and the general public. Such hosting activities were typically pretty short lived as a popular TinyMUD deployment would soon start impact the other work/applications that where being used on the same server, but there was a sufficient number of servers on the Internet that players could always find a new virtual environment to explore and play in.

Commercial virtual worlds found a new lease of life with the introduction of the first generation of Massively Multiplayer Online Games (MMOGs) in 1997 when Origin Systems launched Ultima Online and NCSoft's launched Linage. These two products were based on the world game models as the earlier MUD implementations but extended these models with a rich 3D interaction model. Rather than describing the virtual environments in text, the first generation MMOGs rendered a graphical representation of those environments in an isometric 3D form. Players were represented in a similar manner and rather than having to type “Go North” a player would just press the up arrow on their keyboard and their character or avatar would move or “walk” in real time towards the top of their display screen (e.g. virtual North).

These rich graphic environment made these MMOGs significantly more attractive to the average user who was used to the 3D graphical environments offered by games such as Doom or Quake and the MUD based game model proved to be as compelling as ever. Ultima online garnered 100,000 users within a year, and proved the MUD model could be commercially successful in the new Internet based online marketplace. So the modern MMOG market was born.

### SUMMARY

The invention is generally related to virtual environments, gaming environments, online communities, and interactive computing, and is specifically related to the use of translucency when displaying objects in a virtual environment to indicate status or state of such objects.

An objective of the present invention is to allow the status of a particular object to be communicated without requiring additional screen real estate as required if you communicate state via additional icons or text. Another objective of the present invention is to allow the communication of object state in a virtual environment without breaking the world model (or illusion of reality) associated with a particular virtual environment as would occur if you displayed an object in alternating colors (flashing) or similar mechanism to indicate a change in state. Another objective of the present invention is to utilize translucency in order to provide a familiar visual cue (as learnt from utilizing 2D user interfaces) to denote objects that are inaccessible to the user or to indicate that the behavior associated with that object will differ from opaque objects present inside the same environment.

### BRIEF DESCRIPTION OF THE DRAWINGS

FIG. 1 shows an illustration of an example of a MUD text-based gaming session.

FIG. 2 shows an illustration of an avatar displayed at various levels of translucency indicating the numberof cloned avatars present inside the same virtual environment.

FIG. 3 is an implementation example in pseudo code.

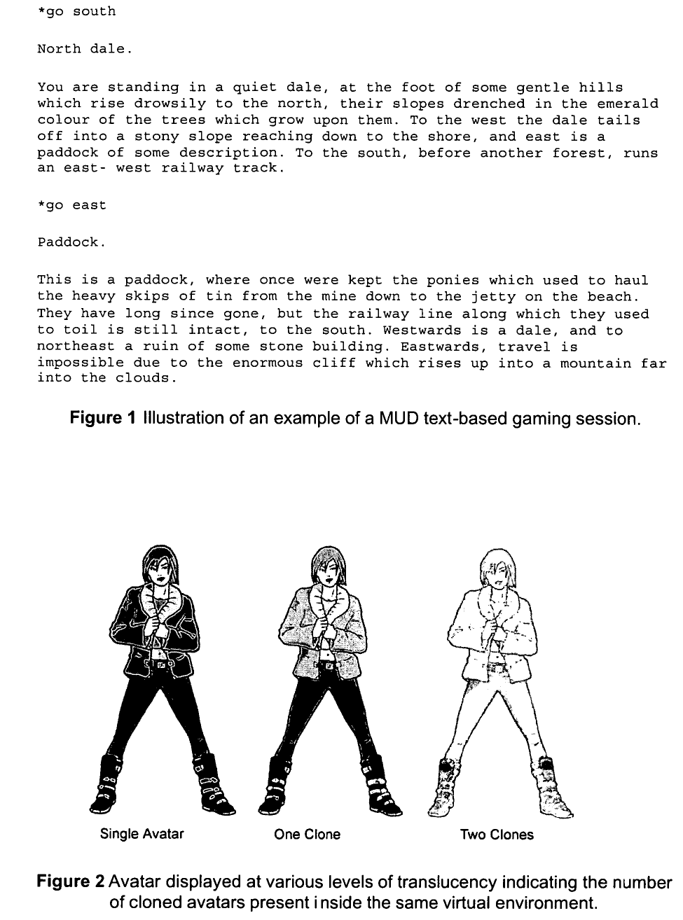

### DETAILED DESCRIPTION

The use of translucency to communicate state in two-dimensional user interfaces has become increasingly common since the release of Apple Computers OS X in 2001. Translucency is typically used to denote UI elements that are inaccessible or unavailable to a user or to denote “window focus” (that is the screen window that will receive input from the keyboard, and/or mouse), the window “in focus” is displayed in opaque form, and all other windows are displayed in translucent form. This use of translucency is very effective, as the visual cue itself provides a logical link between UI elements that are available to the user and so are displayed in an opaque form, and those elements that are not accessible and so are not displayed. The display of UI elements in translucent form provides a link between these states, wherein UI elements are not immediately available.

The present invention allows the status or state of objects inside a virtual environment to be communicated through the use of translucency when displaying that object.

For instance:

Each user inside a virtual environment is represented via an avatar. In such an environment those users who are online and active are represented via avatars that are displayed in opaque form and those users who are online but have been inactive for greater than five minutes are represented via avatars that are displayed in translucent form.

The present invention leverages end users familiarity with the use of translucency associated with two dimensional user interfaces to provide a visual cue or indication of the status of a particular object.

The use of translucency to indicate object state inside a virtual environment also allows the communication of state without requiring additional screen real estate, as would required if text labels or icons where to be used to communicate state.

Finally the use of translucency allows the communication of state without breaking the world model (or illusion) associated with a particular the virtual environment that may occur with the intrusive display of a text label or other method to indicate state or change in state.

Use Case

Each user inside a virtual environment is represented via an avatar. User communication inside this virtual environment is initiated though users moving their avatars so that they are in close proximity.

Users may clone their avatar so that they may be present in several virtual locations at any given time, so allowing users to take part in multiple conversations or “hang out” in multiple virtual locations simultaneously. Inside this virtual environment, each time a user avatar is cloned all avatars associated with that user will be displayed in a progressively more translucent form with each new cloning operation. See FIG. 2.

When a user chooses to terminate a cloned avatar, all avatars associated with that user will be displayed in a progressively more opaque form with each termination operation.

This use of translucency offers other users a useful cognitive prompt for other users with regards to the number of clones that a user is operating and the so level of attention that they can expect to receive from that user.

Implementation Strategies

The implementation of the present invention is very simple, as the display models provided by modern operating systems such as Microsoft Windows XP (with DirectX 7.0 and above) and Apple Computer OS X 10.3 provide graphic primitives that allows programmers to display objects at specified level of translucency.

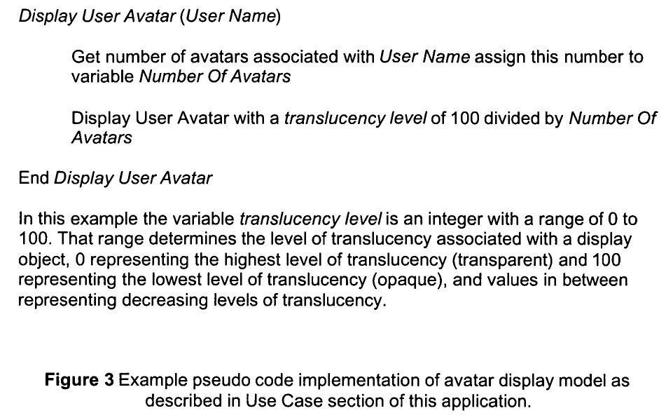

See FIG. 3 for an example pseudo code implementation of avatar display model as described in Use Case section of this application.

### INDUSTRIAL APPLICABILITY

Advantages provided by the invention include: the communication of object state inside a virtual environment without requiring additional screen real estate; reduction of the learning curve associated with a virtual environment by leveraging visual cues to indicate object state that are already familiar to the user; the communication of object state without breaking the world model (or illusion of reality) associated with a particular virtual environment.

The present invention may be conveniently implemented using a conventional general purpose or a specialized digital computer or microprocessor programmed according to the teachings of the present disclosure. Appropriate software coding can readily be prepared by skilled programmers based on the teachings of the present disclosure, as will be apparent to those skilled in the software art.

In some embodiments, the present invention includes a computer program product which is a storage medium (media) having instructions stored thereon/in which can be used to program a computer to perform any of the processes of the present invention. The storage medium can include, but is not limited to, any type of disk including floppy disks, optical discs, DVD, CD ROMs, microdrive, and magneto optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

The foregoing description of the present invention has been provided for the purposes of illustration and description. It is not intended to be exhaustive or to limit the invention to the precise forms disclosed. Many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A system for communicating object status in a virtual environment using translucency, comprising:
a virtual environment;
a virtual representation of a user or object within said virtual environment; and
wherein the virtual representation of the user or object is displayed in a translucent form to represent a change in that user or object status within the virtual environment.

2. A method for communicating object status in a virtual environment using translucency, comprising the steps of:
providing a virtual environment;
displaying a virtual representation of a user or object within said virtual environment;
detecting a change in that user or object status within the virtual environment; and
displaying the virtual representation of the user or object in a translucent form to represent the change in that user or object status.
